(19) United States
(12) Patent Application Publication
(10) Pub. No.: US 2025/0050797 A1
(43) Pub. Date: Feb. 13, 2025

(54) CAM AND CAM POST ASSEMBLIES FOR SECURING A FILTER CANISTER TUBE PLATE ON A SUPPORT RING

(71) Applicant: Bulk Tank, Inc., Park Hills, MO (US)

(72) Inventors: David E. Sisk, Bonne Terre, MO (US); Peter Kemp, Crestwood, MO (US); Roger Breakfield, Farmington, MO (US); Andrew Boyer, Bonne Terre, MO (US); Travis Kinneman, Fredericktown, MO (US); Todd Watkins, Farmington, MO (US); Dylan Whitter, Bonne Terre, MO (US)

(21) Appl. No.: 18/678,805

(22) Filed: May 30, 2024

Related U.S. Application Data
(60) Provisional application No. 63/517,978, filed on Aug. 7, 2023.
(60) Provisional application No. 63/518,427, filed on Aug. 9, 2023.

(51) Int. Cl. B60P 3/22

(52) U.S. Cl. CPC B60P 3/221; B60P 3/226; B60P 3/2265

(57) ABSTRACT

A cam assembly of a cam and a cam post replace each threaded fastener used in attaching a tube plate to a support ring of a bulk tank filter canister. A plurality of cam assemblies replace the threaded fasteners of the filter canister and enable the tube plate to be easily and quickly separated from the support ring when servicing the filter tubes suspended by the tube plate in the filter canister.

### CROSS-REFERENCE TO RELATED APPLICATIONS

This application claims priority from U.S. Provisional Patent Application Ser. No. 63/517,978 which was filed on Aug. 7, 2023, and claims priority from U.S. Provisional Patent Application Ser. No. 63/518,427 which was filed on Aug. 9, 2023.

### FIELD

This disclosure pertains to the components of a filter canister employed in filtering dust from air used to convey bulk dry goods to a tank of a bulk tank trailer. Specifically, this disclosure pertains to the structural configuration of cam and cam post assemblies that are removably attachable to a tube plate that suspends filter tubes inside a filter canister to secure the tube plate to a support ring in the filter canister.

### BACKGROUND

A bulk tank trailer is designed for the movement of bulk dry goods, for example and without limitation, grains, flour, plastic pellets, granular materials or other similar materials that are capable of being pneumatically conveyed. A bulk tank trailer is typically loaded by pneumatically conveying the bulk dry goods in a flow of air from a supply source of the goods into the interior of the tank of the bulk tank trailer.

Filter canisters are employed on the tank of a bulk tank trailer. The filter canisters filter dust from the air employed in conveying the bulk dry goods to the tank of the bulk tank trailer. A typical filter canister has an inlet opening that communicates with the interior of the tank. The inlet opening of the filter canister receives dusty air from the tank that has been employed in conveying the bulk dry goods to the tank. The filter canister contains a filter assembly that filters dust from the dusty air passing through the filter canister. The filter canister also has an outlet opening that communicates air that has been filtered by the filter assembly in the filter canister with the exterior environment of the filter canister.

The typical filter assembly of a filter canister is comprised of an annular support ring that extends around the interior surface of the cylindrical filter canister. The support ring supports a circular tube plate on the support ring. The tube plate has a plurality of circular holes through the tube plate. Each of the circular holes receives and suspends a cylindrical filter tube below the tube plate. Each filter tube receives dusty air directed into the filter canister from the tank on an exterior surface of the tube. The dusty air passes through the filter tubes and is filtered by the filter tubes before entering the interior bores of the filter tubes. The filtered air then passes from the interior bores through top openings of the filter tubes and exits the interior of the filter canister through the outlet opening.

The typical tube plate has fastener holes around a perimeter edge of the tube plate. The support ring has fasteners holes around the support ring that align with the fastener holes of the tube plate. The tube plate is attached on top of a support ring in the interior of the filter canister by a plurality of threaded fasteners. The thread fasteners pass through aligned holes through the tube plate and the support ring adjacent to the peripheral edge of the tube plate. Each threaded fastener is typically comprised of at least a screw threaded bolt and a nut removably attachable to the bolt.

Over time, each of the threaded fasteners can seize together either from galling or from corrosion. The seized fasteners make it difficult to remove the tube plate from the support ring when servicing or replacing the filter tubes suspended by the tube plate. At times, replacing a seized fastener requires drilling out the fastener. This results in drilling through the aligned fastener holes around the peripheral edge of the tube plate and around the support ring, increasing the diameter dimensions of the holes from their original diameter dimensions. The increase in the diameter of the fastener holes creates locations for leaks to occur, which enables dusty air to pass through the leaks and negates the effectiveness of the filter canister. The increase in diameter dimensions can also require that all of the fastener assemblies be replaced with larger fastener assemblies.

### SUMMARY

The cam and cam post assemblies of this disclosure are designed and constructed to replace threaded fasteners employed in securing a tube plate on top of a support ring in a filter canister. The cam assemblies are removably attachable to the top surface of the tube plate by the cam posts and replace the use of nut and bolt fasteners with mating threads that can seize together. Additionally, the structural configurations of the cam and cam post assemblies enables them to be more quickly attached to the top surface of the tube plate than threaded fasteners and enables them to be more quickly removed from the top surface of the tube plate than threaded fasteners.

Each cam and cam post assembly is comprised of a cam and a cam post. The cam has a length with an engagement portion at a first, proximal end of the cam. A handle portion of the cam extends from the engagement portion to a distal end of the cam opposite the proximal end of the cam.

The engagement portion of the cam has a pivot pin with a pivot axis that is oriented horizontally over the tube plate in use. The engagement portion also has a cam surface on the exterior of the engagement portion. The cam surface is oriented parallel to the pivot axis.

The handle portion of the cam has a perpendicular section. The perpendicular section of the handle portion has a structural configuration that extends from the engagement portion in a direction having a perpendicular orientation relative to the pivot axis. In some embodiments the handle portion also has a curved section. The curved section of the handle portion has a structural configuration that extends from the perpendicular section in a direction that curves away from the perpendicular orientation direction.

The handle portion also has a top surface and an opposite bottom surface. The bottom surface opposes and is spaced above the top surface of the tube plate when the cam is removably attached to the top surface of a tube plate.

In some embodiments the handle portion also has an interior surface and an opposite exterior surface. The interior surface of a handle portion is directed toward a center of the tube plate when the cam assembly is attached to the top surface of the tube plate. The interior surface has a structural configuration that curves around the center of the tube plate. The exterior surface of the handle portion is directed away from the center of the tube plate when the cam assembly is removably attached to the top surface of the tube plate. The exterior surface opposes the cylindrical interior surface of the filter canister and has a structural configuration that curves around the center of the tube plate.

In another embodiment the cam has a two-piece construction with a handle in the form of a straight rod that is removably attachable to the engagement portion of the cam.

The cam post has an embodiment with a flange at the bottom end of the cam post. The cam post is installed upwardly through aligned holes in the support ring and the tube plate. The flange engages against the underside of the support ring of the filter canister when installing the cam post upwardly through a fastener hole in the bottom of the support ring. A knurled surface or a ridged surface on the cam post engages against the interior surface of the fastener hole to secure the cam post in the fastener hole.

In another embodiment the cam post is installed downwardly through aligned holes in the tube plate and the support ring. The cam post has flat surfaces on opposite sides of the cam post that engage against complimentary flat surfaces on opposite sides of the fastener hole in the support ring. The flat surfaces of the cam post engage against the flat surfaces of the fastener hole in the support ring and hold the cam post in a fixed position in the fastener hole and prevent the cam post from rotating in the fastener hole.

In another embodiment the bottom end of the cam post has threads that screw into internally screw threaded holes in the support ring of the filter canister.

The top end of the cam post is provided with a notch. The notch is dimensioned to receive the pivot pin or cam pin of the cam in the notch when releasably attaching the cam to the cam post.

In a further embodiment the notch in the top end of the cam post is replaced with a hole that receives a removable cam pin to attach the cam to the cam post.

One embodiment of the cam post has a two-piece construction with a bottom end that is screw threaded into a top end.

In a still further embodiment of the cam post the hole in the cam post receives a side pin that projects from a side of the cam to attach the cam to the cam post.

The cam assembly is one cam assembly of a plurality of cam assemblies that are each removably attachable to the tube plate and the support ring. Each of the cam assemblies is spatially positioned around the circular perimeter edge of the tube plate when the plurality of cam assemblies are removably attached to the top surface of the tube plate and the support ring. In the cam assembly with cams having curved handles, the plurality of cam assemblies are positioned end to end in a circular arrangement extending around and within the perimeter edge of the tube plate when the plurality of cam assemblies are removably attached to the tube plate and support ring. The curved configurations of the handle portions of the cam assemblies positions the handles in a spaced relationship radially inward from the interior surface of the filter canister when the plurality of cam assemblies are attached to the top surface of the tube plate.

In further embodiments of the cam assemblies the handle portion of a cam assembly has a straight configuration that extend radially inward toward the center of the tube plate. In still further embodiments, the handle portion is configured as a removable rod that can be used to operate each cam assembly.

### DESCRIPTION OF THE DRAWINGS

Further objects and features of the cam and cam post assemblies of this disclosure are set forth in the following detailed description of the cam and cam post assemblies and in the drawing figures.

FIG. 1 is a representation of a partial view of the interior of a prior art filter canister and a prior art tube plate secured by threaded fasteners to a support ring in the interior of the filter canister.

FIG. 2 is a representation of a perspective view of a plurality of the cam and cam post assemblies of this disclosure removably attached to the top surface of a tube plate.

FIG. 3 is a representation of a top, plan view of a cam having a curved handle portion of this disclosure.

FIG. 4 is a representation of a side elevation view of the cam of FIG. 3.

FIG. 5 is a representation of a partial view of an interior of a filter canister employing a cam and cam post assembly of this disclosure in removably attaching a tube plate on a support ring in the interior of the filter canister.

FIG. 6 is a representation of a first position of a cam and cam post assembly in removably attaching the cam to the cam post on the top surface of a tube plate supported on a support ring.

FIG. 7 is a representation of the cam removably attached to the cam post on the top surface of the tube plate.

FIG. 8 is a representation of the cam being moved to its removably attached position on the top surface of the tube plate.

FIG. 9 is a representation of the cam being moved further to its removably attached position on the top surface of the tube plate.

FIG. 10 is a representation of the cam in the removably attached position on the top surface of the tube plate.

FIG. 11 is a representation of an embodiment of a cam post employed in attaching the cam to the top surface of the tube plate.

FIG. 12 is a representation of a side elevation view of a further embodiment of a cam post.

FIG. 13 is a representation of a cross section view of the cam post of FIG. 12 in the plane of line 13-13.

FIG. 14 is a representation of a side elevation view of a further embodiment of a cam post with external screw threads.

FIG. 15 is a representation of a side elevation view of a further embodiment of the cam post having opposite flat surfaces.

FIG. 16 is a bottom plan view of the cam post of FIG. 15.

FIG. 17 is a perspective view of the cam post of FIG. 15.

FIG. 18 is a representation of a partial plan view of a support ring used with the cam post of FIGS. 15-17.

FIG. 19 is a representation of a side elevation view of a further embodiment of a cam post with a cam pin hole.

FIG. 20 is a representation of a top perspective view of a tube plate employing an embodiment of cam assemblies comprising the cam post of FIG. 19.

FIG. 21 is a representation of a perspective view of a removable pin employed with the embodiment of the cam and cam post assemblies represented in FIG. 20.

FIG. 22 is a representation of a top plan view of a further embodiment of a cam.

FIG. 23 is a representation of a top perspective view of a tube plate employing the embodiment of the cam represented in FIG. 22.

FIG. 24 is a representation of a perspective view of a tube plate employing a further embodiment of cam assemblies.

FIG. 25 is a representation of a side elevation view of the cam of FIG. 24.

FIG. 26 is a representation of a top plan view of the cam of FIG. 25.

FIG. 27 is a representation of a perspective view of the cam of FIG. 25 and FIG. 26.

FIG. 28 is a representation of a partial view of an interior of a filter canister employing the cam and cam post assembly of FIGS. 24-27.

### DETAILED DESCRIPTION

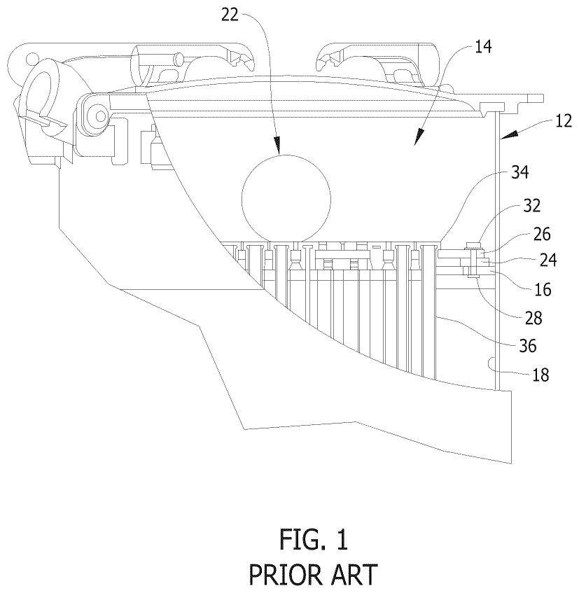

FIG. 1 is a representation of a partial view of a prior art filter canister 12 and a portion of the interior volume 14 of the canister. As represented in FIG. 1, a tube plate support ring 16 is secured to the cylindrical interior surface 18 of the canister 12. The support ring 16 extends around the interior surface 18 of the filter canister 12 and is positioned just below the outlet opening 22 of the filter canister 12. An annular gasket 24 is positioned on top of the support ring 16. The tube plate 26 is positioned on top of the gasket 24. A plurality of aligned fastener holes extend through the support ring 16, the gasket 24 and the tube plate 26 adjacent to the peripheral edge of the tube plate. A plurality of fasteners, each comprising at least a threaded bolt 28 and a threaded nut 32 extend through the aligned holes of the support ring 16, the gasket 24 and the tube plate 26 and secure the tube plate on top of the support ring.

A plurality of filter tube holes pass through the tube plate 26. Each filter tube hole in the tube plate 26 receives a grommet 34. Each grommet 34 secures a cylindrical filter tube 36 suspended by the grommet 34 below the tube plate 26. In operation of the filter canister 12, the exterior surface of each filter tube 36 receives dusty air conveyed into the filtered canister 12 as discussed earlier. The dusty air passes through and is filtered by the filter tubes 36 before flowing through the interior bores of the filter tubes and exiting the interior 14 of the filter canister 12 through the outlet opening 22.

As represented in FIG. 1, the tube plate 26 is attached to the gasket 24 and the top of the support ring 16 by the plurality of threaded fasteners 28, 32. The cam and cam post assembly of this disclosure is designed and constructed to replace the threaded fasteners 28, 32 employed in securing the tube plate 26 on top of the support ring 16 in the filter canister 12.

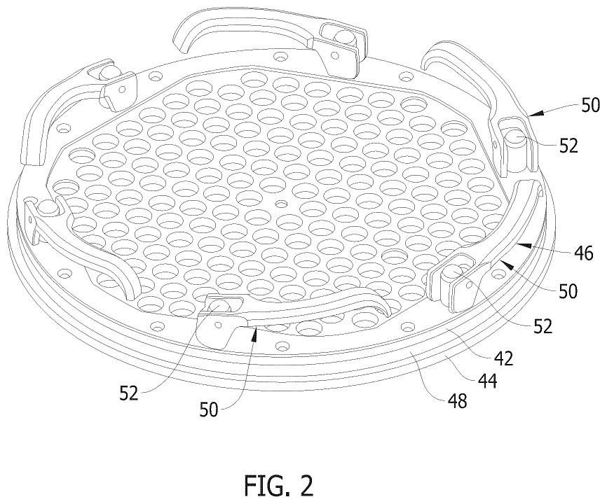

FIG. 2 is a representation of a perspective view of a tube plate 42 secured on top of a support ring 44 by a plurality of cam and cam post assemblies 46 of this disclosure. An annular gasket 48 is positioned between the support ring 44 and the tube plate 42. Each cam and cam post assembly 46 is comprised of a cam 50 and an associated cam post 52 that extends through the aligned holes through the support ring 44, the gasket 48 and the tube plate 42.

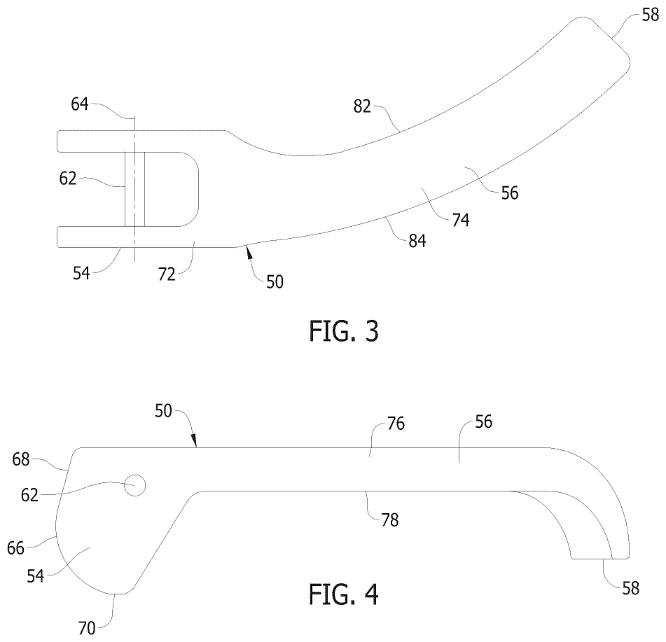

Referring to FIG. 3 and FIG. 4, in a first embodiment of the cam and cam post assemblies each cam 50 has a length with an engagement portion 54 at a first end or proximal end of the cam. A handle portion 56 of the cam 50 extends from the engagement portion 54 to a second end or distal end 58 of the cam.

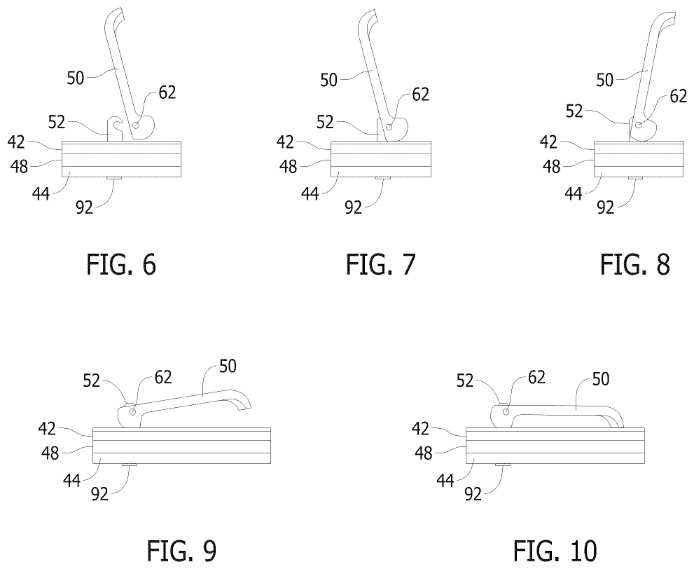

The engagement portion 54 of the cam 50 has a forked configuration with pivot holes through prongs of the fork that receive a cam pin or pivot pin 62. The pivot pin 62 is used in removably attaching the cam 50 to its associated cam post 52. The pivot pin 62 has a pivot axis 64 through the center of the pivot pin. The engagement portion 54 has a cam surface 66 that extends around the exterior of the engagement portion. The cam surface 66 is oriented parallel to the pivot axis 64. As represented in FIG. 4, the cam surface 66 has a flat portion 68 positioned a first distance from the pivot axis 64 that, with the flat portion 68 of the cam surface positioned opposing the tube plate 42, provides sufficient clearance for the cam 50 and specifically the pivot pin 62 to be coupled to the cam post 52 as represented in FIG. 6 and FIG. 7. As the cam surface 66 extends around the pivot axis 64 in a counterclockwise direction as viewed in FIG. 4, the distance of the cam surface 66 from the pivot axis 64 increases until the cam surface 66 terminates at a closed portion 70 of the cam surface. The closed portion 70 of the cam surface 66 engages against the top of the tube plate 42 when the cam assembly 46 is moved to its closed position on the tube plate 42 as represented in FIG. 10, securing the tube plate 42 and the gasket 48 to the support ring 44.

The handle portion 56 of the cam assembly 46 has a perpendicular section 72. The perpendicular section 72 of the handle portion has a structural configuration that extends from the engagement portion 54 and the pivot axis 64 in a direction having a perpendicular orientation relative to the pivot axis 64 as represented in FIG. 3. The handle portion 56 also has a curved section 74 that extends from the perpendicular section 72. The curved section 74 of the handle portion 56 has a structural configuration that extends from the perpendicular section 72 in a direction that curves away from the perpendicular orientation direction as represented in FIG. 3. The curved section 74 extends from the perpendicular section 72 to the distal end 58 of the cam 50.

The handle portion 56 also has a top surface 76 and an opposite bottom surface 78 as represented in FIG. 4. The bottom surface 78 opposes and is spaced above the top surface of the tube plate 42 when the cam assembly 46 is removably attached to the top surface of the tube plate as represented in FIG. 2. The spacing between the bottom surface 78 of the handle portion 56 and the top surface of the tube plate 42 provides ample access for the insertion of the fingers of a user's hand to enable manual manipulation of the handle portion 56 and the cam 50.

The handle portion 56 also has an interior surface 82 and an opposite exterior surface 84 as represented in FIG. 3. The interior surface 82 is directed toward a center of the tube plate 42 when the cam 50 is attached to the top surface of the tube plate as represented in FIG. 2. As represented in FIG. 2, the interior surface 82 has a structural configuration that curves around the center of the tube plate 42. The exterior surface 84 of the handle portion 56 is directed away from the center of the tube plate 42 and toward the interior surface 18 of the filter canister 12 when the cam 50 is removably attached to the top surface of the tube plate 42. The exterior surface 84 opposes the cylindrical interior surface 18 of the filter canister 12 and also has a structural configuration that curves around the center of the tube plate 42. The positioning of the cam 50 on the tube plate 42 spaces the exterior surface 84 of the handle portion 56 from the interior surface 18 of the filter canister 12 and provides ample access for the insertion of a user's hand between the exterior surface 84 of the handle portion 56 and the interior surface of the filter canister 12.

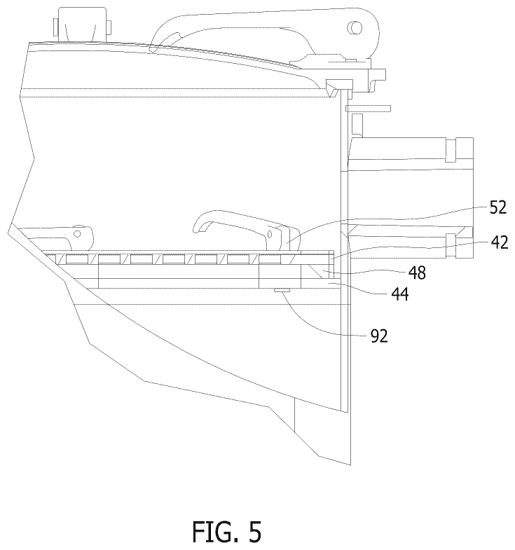

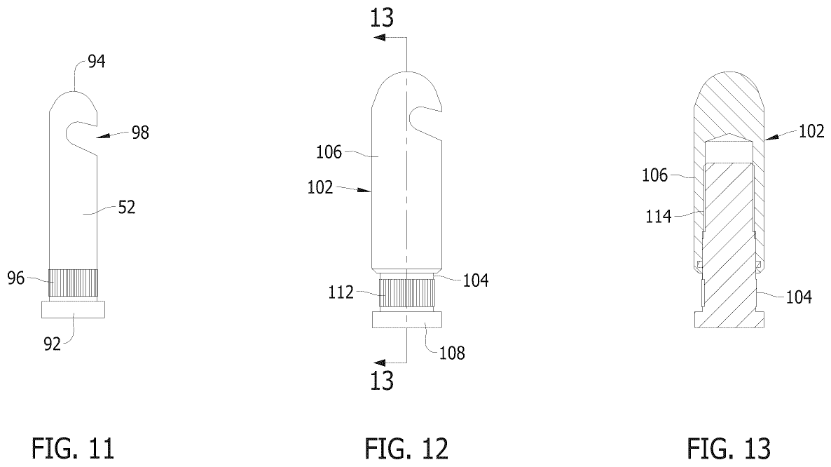

A first embodiment of a cam post 52 of a cam and cam post assembly of this disclosure is represented in FIG. 5 and FIG. 11. In FIG. 5 the cam post 52 is shown inserted upwardly from below the support ring 44 through aligned fastener holes through the support ring 44, the gasket 48 and the tube plate 42.

As represented in FIG. 5 and FIG. 11, the cam post 52 has an elongate, cylindrical configuration that extends upward from a flange 92 at the bottom end of the cam post 52 to a rounded, tapered top end 94 of the cam post. The flange 92 has an annular configuration that is dimensioned larger than the fastener hole through the support ring 44. A knurled or ridged surface 96 extends around the cam post 52 adjacent the bottom flange 92. The knurled surface 96 is dimensioned for a tight friction fit between the knurled surface 96 and the interior surfaces of the fastener holes passing through the support ring 44 when attaching the cam post to the support ring. A pivot pin opening or notch 98 is provided into the side of the cam post 52 adjacent the top end 94 of the cam post. The opening or notch 98 is dimensioned to receive the cam pivot pin 62 in the notch.

As represented in FIG. 5, FIG. 6 and FIG. 7, the cam post 52 is inserted upwardly through a fastener hole of the support ring 44 and through aligned fastener holes of the gasket 48 and the tube plate 42. In attaching the cam assembly 46 to the top surface of the tube plate 42, the cam 50 is first moved into position adjacent the cam post 52 as represented in FIG. 6.

As represented in FIG. 7, the cam 50 is then moved into engagement with the cam post 52 with the cam pin or pivot pin 62 of the cam inserted into the notch 98 in the side of the cam post 52.

As represented in FIG. 8, the cam 50 is then moved toward its closed and locked position by moving the handle portion 56 of the cam downwardly in a clockwise direction around the pivot pin 62 toward the top surface of the tube plate 42.

As represented in FIG. 9, the cam 50 is continued to be moved to its closed position by continuing to move the handle portion 56 of the cam downward toward the top surface of the tube plate 42. This movement of the cam 50 causes the engagement portion 54 of the cam to press downwardly on the top surface of the tube plate 42 with an increasing force, compressing the gasket 48 between the tube plate 42 and the support ring 44.

The downward movement of the handle portion 56 of the cam 50 is continued until the distal end 58 of the cam engages against the top surface of the tube plate 42 as represented in FIG. 10. This position of the cam 50 causes the engagement portion 54 of the cam assembly to exert its greatest force against the top surface of the tube plate 42 compressing the gasket 48 between the tube plate 42 and the support ring 44.

FIG. 12 and FIG. 13 represent an alternative construction of the cam post 102. The cam post 102 of FIG. 12 and FIG. 13 has a two-part construction comprised of a bottom end or center shaft 104 and a top end or outer shaft 106. The center shaft 104 as a cylindrical configuration with a bottom flange 108 and knurling 112 just as in the FIG. 11 embodiment of the cam post 52. The outer shaft 106 has a hollow, tubular configuration. There is mating screw threading 114 that extends around the outer cylindrical surface of the center shaft 104 and the inner cylindrical surface of the outer shaft 106 that enables the outer shaft 106 to be screw threaded onto the center shaft 104. The screw threading 114 also enables the outer shaft 106 to be adjustably positioned over the center shaft 104 to adjust the length of the cam post 102. The cam post 102 is used in the same manner as the cam post 52 of FIG. 11 with the cam 50 in securing the tube plate 42 on the support ring 44. The ability to adjust the length of the cam post 102 also enables an adjustment in the engaging force that the cam 50 will exert on the tube plate 42 when the cam post 102 is used in securing the tube plate 42 on the support ring 44.

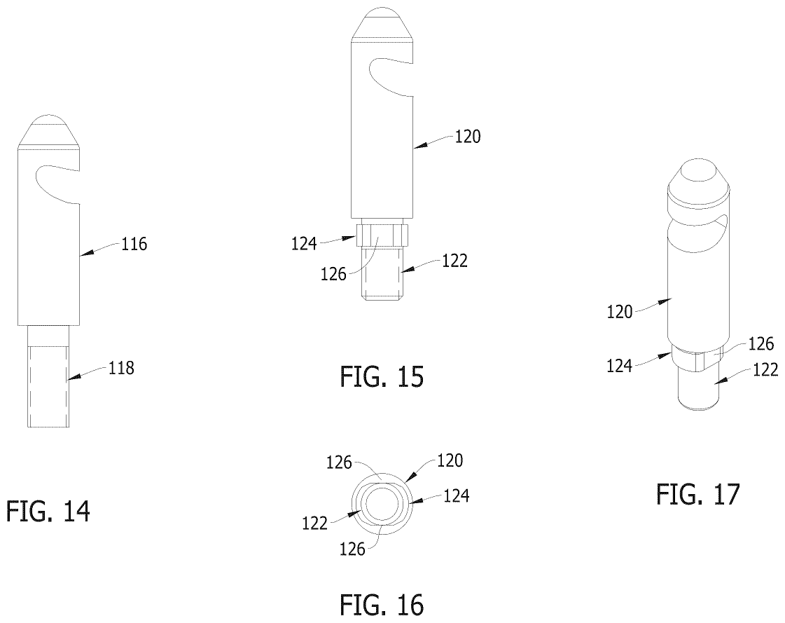

FIG. 14 is a representation of a further embodiment of the cam post 116. The cam post 116 of FIG. 14 is similar to that of FIGS. 11-13 except that the bottom end of the cam post 116 is provided with external screw threading 118 in place of the flange 92. The screw threading 118 mates with internal screw threads of cam post holes through the support ring 44.

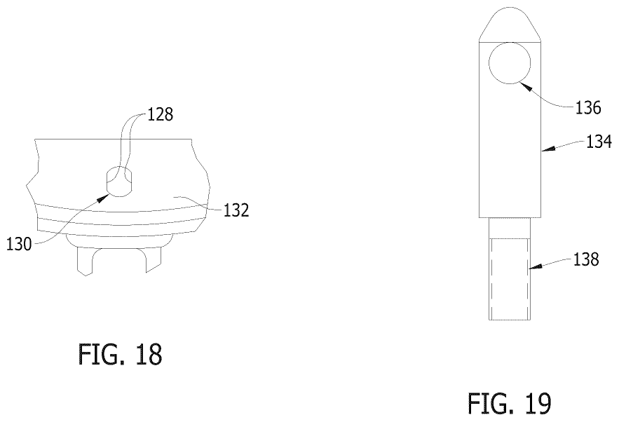

FIGS. 15-17 represent an embodiment of the cam post 120 that is similar in construction to the cam post 116 of FIG. 14. The cam post 120 also has external screw threading 122 at the bottom end of the cam post. However, just above the screw threading 122 there is an enlarged annular band 124 that is dimensioned larger than the screw threading 122. The band 124 has a pair of flat surfaces 126 on opposite sides of the band. The annular band 124 and the flat surfaces 126 are dimensioned to be received in and engage against complimentary flat surfaces 128 on opposite sides of post holes 130 though the support ring 132 such as the post hole 130 represented in the partial view of a support ring 132 in FIG. 18. The engagement of the cam post flat surfaces 126 against the flat surfaces 128 of the post hole 130 through the support ring 132 hold the cam post 120 in a fixed position on the support ring 132 as a nut is screw threaded on the screw threading 122 of the cam post 120 when attaching the cam post 120 to the support ring 132.

FIG. 19 is a representation of a still further embodiment of the cam post 134. The cam post 134 of FIG. 19 is similar in construction to that of the cam post 116 of FIG. 14 except that the notch in the upper portion of the cam post 116 of FIG. 14 is replaced by a cam pin hole 136 through the cam post 134. The cam post 134 of FIG. 19 also has external screw threading 138 on the bottom portion of the cam post.

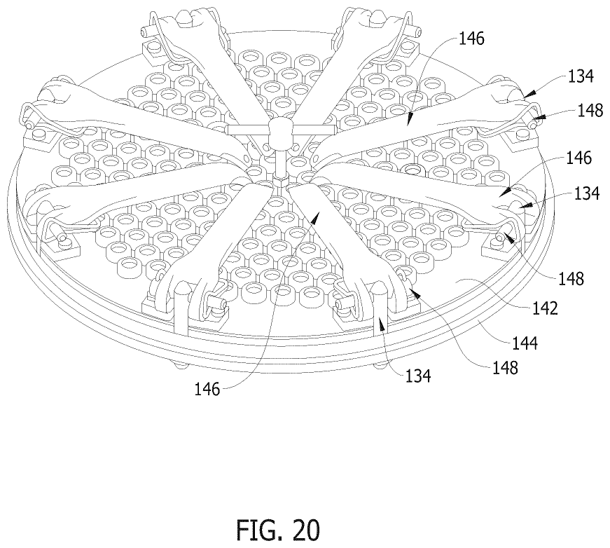

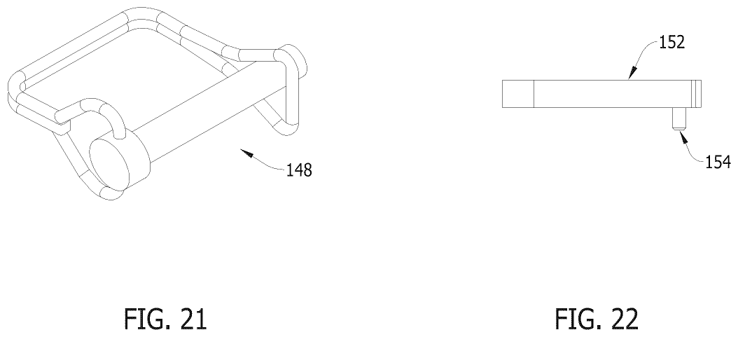

FIG. 20 is a representation of a top perspective view of a tube plate 142 secured on a support ring 144 by the cams 146 and the cam posts 134 of FIG. 19. The cams 146 are substantially the same in construction as the cams 50 of FIGS. 3 and 4, except that the cams 146 have straight handles that extend toward the center of the tube plate 142. In FIG. 20 the screw threading 138 of the cam posts 134 is inserted through holes in the tube plate 142 and is screwed into internally screw threaded holes in the support ring 144. In this way the cams 146 attached to the cam posts 134 on top of the tube plate 142 secure the tube plate 142 in position on the top of the support ring 144. The cams 146 of FIG. 20 are secured to the cam pin holes 136 of the cam posts 134 by removable pivot pins 148 of the type represented in FIG. 21. The pivot pin 148 represented by FIG. 21 is a clevis type pin. Other equivalent types of pins such as cotter pins, bridge pins, safety pins, etc. could be used in place of the clevis pin 148 of FIG. 21. In FIG. 20 the pivot pins 148 are inserted through the pivot pin holes in the cams 146 and through the cam pin holes 136 in the cam posts 134 to secure the cams 146 to the cam posts 134.

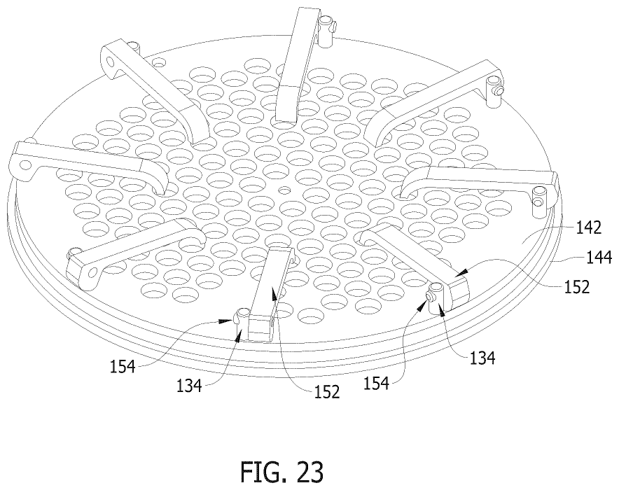

FIG. 22 is a representation of a plan view of a cam 152 that is similar in construction to the cam 146 of FIG. 20. However, instead of a cam pin hole extending through the cam 146 of FIG. 20, the cam 152 has a pivot pin 154 fixed to and projecting from one side of the cam. As represented in FIG. 23, the pivot pins 154 of the cams 152 are inserted into the cam pin holes 136 of the cam posts 134 extending through the tube plate 142 and screw threaded into screw threaded holes of the support ring 144. The pivot pins 154 of the cams 152 secure the cams 152 to the cam posts 134 and thereby secure the cams 152 to the top surface of the tube plate 142 for functioning in the same manner as the previously described embodiments of the cam assemblies.

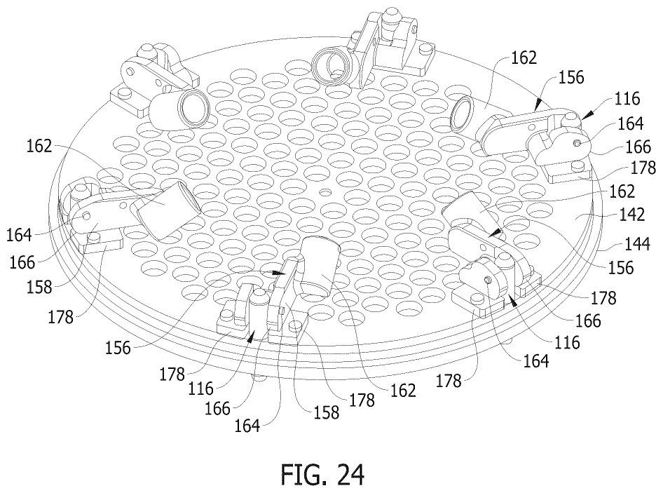

FIGS. 24-28 represent a still further embodiment of the cam assembly of this disclosure. The cam assemblies represented in FIGS. 24-28 employ the cam post 116 of FIG. 14. However, the cam assemblies could employ the other embodiments of the cam posts described herein. As represented in FIGS. 24-28, the cam posts 116 extend through holes in the tube plate 142 and are screw threaded into internally screw threaded holes in the support ring 144. The notches in the pin hooks 116 are directed toward the center of the tube plate 142.

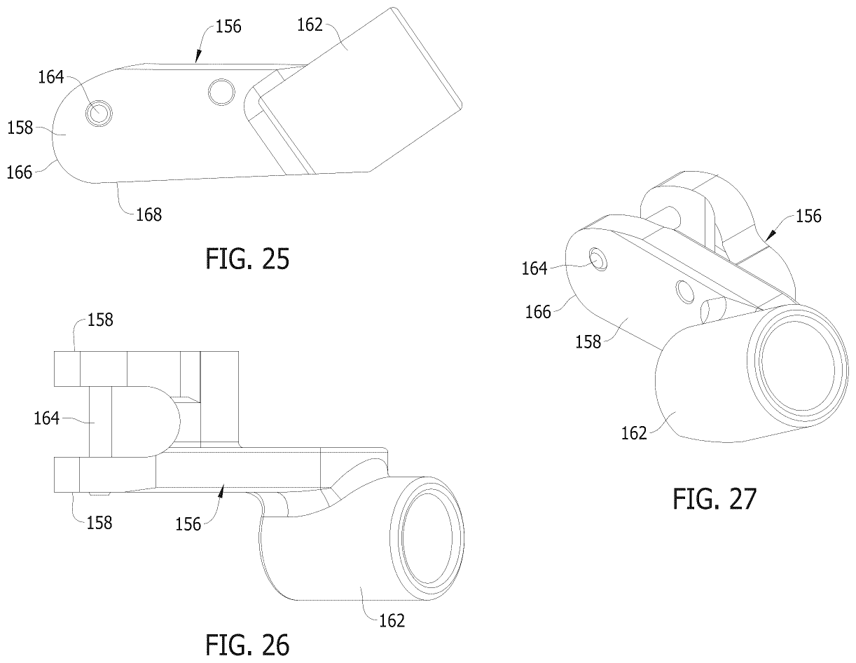

The cam assemblies of FIGS. 24-28 comprise cams 156 that are similar in construction and functioning to the cams 50 of FIGS. 2-10. As represented in FIGS. 25-27, the cams 156 have lengths with engagement portions 158 at first ends of the cams and handle attachment portions 162 formed at the opposite, second ends of the cams 156.

The engagement portion 158 of each cam 156 has a cam pin or pivot pin 164 press fit in a pivot hole in the cam. The pivot pin 164 is used to removably attach the cam 156 to its associated cam post 116 by engagement of the pivot pin into the notch of the cam post. The engagement portion 158 of each cam also has cam surfaces 166 that extend around the exterior of the engagement portion. The cam surfaces 166 are oriented parallel to the pivot axis of the pivot pin 164. As represented in FIG. 25, the cam surfaces 166 have flat portions positioned a first distance from the pivot pin 164 that provide sufficient clearance for the cam 156 and specifically the pivot pin 164 to be coupled to the cam post 116. As the cam surfaces 166 extend around the pivot pin 164 in a counterclockwise direction, the distance of the cam surfaces 166 from the pivot pin 164 increases until the cam surfaces 166 terminate at closed portions 168 of the cam surfaces. The closed portions 168 of the cam surfaces 166 engage against the top surface of the tube plate 142 when the cam 156 is moved to its closed position on the tube plate, securing the tube plate 142 and the gasket to the support ring 144.

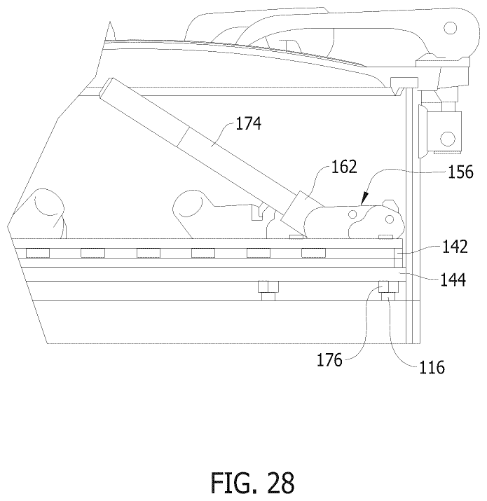

The handle portion 162 of the cam assembly 156 is a tubular, cylindrical socket that has a center axis that is perpendicular to the center axis of the pivot pin 164. As represented in FIG. 28, a rod 174 is removably inserted into the tubular socket configuration of the handle portion 162. The rod 174 has a straight length that extends toward the center of the tube plate 142 when the rod is inserted into the handle portion 162. The one rod 174 can conveniently be used to operate all of the cam assemblies 156.

As represented in FIG. 24 and FIG. 28, the cam posts 116 are inserted through the aligned fastener holes of the support ring 144, the gasket and the tube plate 142. The cam posts 116 are shown secured by screw threaded nuts 176 at the bottoms of the cam posts. The cam posts 116 could be screw threaded into internally screw threaded holes in the support ring 144 to secure the cam posts to the support ring.

In attaching the cams 156 to the top surface of the tube plate 142, the cams 156 are first moved into positions adjacent their associated cam posts 116 as represented in FIG. 24 and FIG. 28. In FIG. 24 the cams 156 are shown positioned on top of a pair of spacer plates 178 that have been secured to the top surface of the tube plate 142 on opposite sides of the cam posts 116. Alternatively, the cams 156 could engage directly against the top surface of the tube plate 142. The cams 156 are moved into engagement with the cam posts 116 with the pivot pins 164 of the cams inserted into the notches in the sides of the cam posts. In other embodiments described previously, a separate pivot pin could be inserted through aligned holes of the cam posts 116 and the cams 156.

As represented in FIG. 28, the cams 156 are moved toward their closed and locked positions by moving the rod 174 inserted into the handle portion 162 of each cam 156 downwardly toward the top surface of the tube plate 142. The downward movement of the rod 174 is continued to cause the cam 156 to move to its closed position. This movement of the cam 156 causes the engagement portion 158 of the cam to press downwardly on the top surface of the tube plate 142 with an increasing force compressing the gasket between the tube plate 142 and the support ring 144.

The downward movement of the rod 174 is continued until the engagement portion 158 of the cam 156 exerts its greatest force against the top surface of the tube plate 142 compressing the gasket between the tube plate and the support ring 144. With the tube plate 142 thereby secured to the support ring 144, the rod 174 can be removed from the cam 156 and moved to the next cam around the periphery of the tube plate 142 to secure that cam to the tube plate.

To remove the tube plate 142 from the support ring 144, the above movements of the cams 156 by the rod 174 are reversed. With each cam 156 moved to this position relative to its associated cam post 116 where the force of engagement of the cam against the top of the tube plate 142 is reduced, each cam 156 can then be disengaged from its associated cam post 116 and removed. Removal of the cams 156 enables the tube plate 142 to be lifted from the cam posts 116 and removed from the support ring 144.

As various changes could be made in the above-described constructions of the cam assemblies without departing from the scope of this disclosure, it is intended that all matter contained in the above description or shown in the accompanying drawings shall be interpreted as illustrative only and not in a limiting sense.

1. A cam and cam post assembly that secures a filter tube plate in a filter canister of a dry bulk tank trailer on a support ring in the filter canister, the assembly comprising:
a cam, the cam having a cam surface on a first end of the cam and the cam having a handle on a second end of the cam;
a pivot pin on the first end of the cam;
a cam post, the cam post having a bottom end that is configured for attaching the cam post to the support ring with the cam post extending upward through the filter tube plate on the support ring, the cam post having a top end with an opening in the top end of the cam post; and
the pivot pin on the first end of the cam is positioned in the opening in the top end of the cam post and attaches the cam to the cam post with the first end of the cam pressing the filter tube plate against the support ring.

2. The cam and cam post assembly of claim 1, further comprising:
the opening in the top end of the cam post is a hole through the top end of the cam post.

3. The cam and cam post assembly of claim 1, further comprising:
the opening in the top end of the cam post is a notch in the top end of the cam post.

4. The cam and cam post assembly of claim 1, further comprising:
the pivot pin is a removable pivot pin that is removably attached on the first end of the cam and is removably attached in the opening in the top end of the cam post.

5. The cam and cam post assembly of claim 1, further comprising:
the pivot pin is fixed to the first end of the cam and projects from a side of the first end of the cam.

6. The cam and cam post assembly of claim 1, further comprising:
the first end of the cam has a forked configuration with pivot holes that extend through prongs of the forked configuration; and
the pivot pin extends through the pivot holes through the prongs of the forked configuration and the pivot pin extends between the prongs.

7. The cam and cam post assembly of claim 1, further comprising:
the handle on the second end of the cam has a curved configuration that curves around a center of the filter tube plate as the handle extends from the first end of the cam to the second end of the cam.

8. The cam and cam post assembly of claim 1, further comprising:
the handle on the second end of the cam has a straight configuration that extends straight toward a center of the filter tube plate as the handle extends from the first end of the cam to the second end of the cam.

9. The cam and cam post assembly of claim 8, further comprising:
the handle comprises a rod that is removably attached to the first end of the cam.

10. The cam and cam post assembly of claim 9, further comprising:
the handle comprises a tubular socket and a rod that is configured for removable insertion into the socket.

11. The cam and cam post assembly of claim 1, further comprising:
the cam post having an exterior surface portion at the bottom end of the cam post that is configured for a tight friction fit between the exterior surface portion and an interior surface of a hole through the support ring that attaches the cam post to the support ring.

12. The cam and cam post assembly of claim 1, further comprising:
the cam post having exterior screw threading at the bottom end of the cam post that is configured for mating with interior screw threading on an interior surface of a hole through the support ring that attaches the cam post to the support ring.

13. The cam and cam post assembly of claim 1, further comprising:
the cam post having a flange at the bottom end of the cam post that is configured to engage against an underside of the support ring when the cam post is inserted upwardly through a hole through the support ring that attaches the cam post to the support ring.

14. The cam and cam post assembly of claim 1, further comprising:
the cam post having a two-part construction comprising a center shaft at the bottom end of the cam post and an outer shaft at the top end of the cam post;
the center shaft has exterior screw threading on the center shaft;
the outer shaft has a tubular configuration with interior screw threading in the tubular configuration of the outer shaft; and
the interior screw threading in the outer shaft mates with the exterior screw threading on the center shaft producing an adjustable connection between the outer shaft and center shaft that enables adjusting a length of the cam post.

15. The cam and cam post assembly of claim 1, further comprising:
a pair of flat surfaces on opposite sides of the bottom end of the cam post;
a pair of flat surfaces on opposite sides of a hole through the support ring; and
the pair of flat surfaces on opposite sides of the bottom end of the cam post are configured to engage against the pair of flat surfaces on opposite sides of the hole through the support ring and hold the cam post fixed in position on the support ring.

16. The cam and cam post assembly of claim 1, further comprising:
the cam and cam post assembly is one cam and cam post assembly of a plurality of cam and cam post assemblies that secure the filter tube plate to the support ring.

17. A cam and cam post assembly comprising;
a cam post that is attachable to a support ring in a filter canister of a dry bulk tank trailer with the cam post extending through a tube plate on the support ring;
a cam that is removably attachable to the cam post, the cam being movable relative to the cam post when attached to the cam post to exert an increasing force against the tube plate.

18. The cam and cam post assembly of claim 17, further comprising:
a pivot pin that is removably attachable to the cam post and is removably attachable to the cam.

19. The cam and cam post assembly of claim 17, further comprising:
a pivot pin attached to the cam; and
the pivot pin is removably attachable to the cam post.

20. The cam and cam post assembly of claim 16, further comprising:
a handle on the cam, the handle having a curved configuration that curves around a center of the tube plate.

21. The cam and cam post assembly of claim 17, further comprising:
a rod, the rod being removably attached to the cam.

22. The cam and cam post assembly of claim 17, further comprising:
the cam post having an exterior surface portion at the bottom end of the cam post that is configured for a tight friction fit between the exterior surface portion and an interior surface of a hole through the support ring that attaches the cam post to the support ring.

23. The cam and cam post assembly of claim 17, further comprising:
the cam post having a flange at the bottom end of the cam post that is configured to engage against an underside of the support ring when the cam post is inserted upwardly through a hole through the support ring that attaches the cam post to the support ring.

24. The cam and cam post assembly of claim 17, further comprising:
the cam post having a two-part construction comprising a center shaft at the bottom end of the cam post and an outer shaft at the top end of the cam post;
the center shaft has exterior screw threading on the center shaft;
the outer shaft has a tubular configuration with interior screw threading in the tubular configuration of the outer shaft; and
the interior screw threading in the outer shaft mates with the exterior screw threading on the center shaft producing an adjustable connection between the outer shaft and center shaft that enables adjusting a length of the cam post.

25. The cam and cam post assembly of claim 17, further comprising:
a pair of flat surfaces on opposite sides of the bottom end of the cam post;
a pair of flat surfaces on opposite sides of a hole through the support ring; and
the pair of flat surfaces on opposite sides of the bottom end of the cam post are configured to engage against the pair of flat surfaces on opposite sides of the hole through the support ring and hold the cam post fixed in position on the support ring.
